(19) United States
(12) Patent Application Publication
(10) Pub. No.: US 2015/0116543 A1
(43) Pub. Date: Apr. 30, 2015

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yusuke Mitarai, Tokyo (JP)

(21) Appl. No.: 14/525,777

(22) Filed: Oct. 28, 2014

(30) Foreign Application Priority Data
Oct. 30, 2013 (JP) 2013-225673

(51) Int. Cl. G06K 9/62; G06K 9/46; H04N 5/232

(52) U.S. Cl. CPC G06K 9/6227; H04N 5/23229; G06K 9/46
USPC 348/231.6; 382/190

(57) ABSTRACT

In order to set appropriate parameters for pattern recognition while reducing a processing amount and a memory capacity for processing, an information processing apparatus includes a first setting unit configured to set a parameter candidate(s) to be used for pattern recognition, a first feature data generation unit configured to generate feature data of image data obtained by using the parameter candidate(s) set by the first setting unit, a storage unit configured to store an estimation model which is a modelization of a relationship between feature data of a plurality of image data obtained by using each of a plurality of model parameters and an evaluation value for each of the model parameters, and an estimation unit configured to refer to the estimation model and estimate an evaluation value for the parameter candidate(s) based on the feature data generated by the first feature data generation unit.

### BACKGROUND OF THE INVENTION

1. Field of the Invention

The present invention relates to an information processing apparatus, an information processing method, and a computer-readable storage medium.

2. Description of the Related Art

Various methods for recognizing where a predetermined object exists in an input image and for recognizing whether a defect exists on a surface of an object have been proposed. In these recognition methods, it is necessary to appropriately set imaging parameters for exposure time and pre-processing parameters for edge extraction performed on an image, for example.

There is known a method for determining parameters for recognition. In this method, first, various parameters are actually set, and next, imaging, pre-processing, etc. is performed. Finally, based on the recognition performance of the image data obtained as a result, parameters are determined.

For example, Japanese Patent Application Laid-Open No. 2007-102458 discusses a method for setting pre-processing parameters for input images. In an apparatus discussed in Japanese Patent Application Laid-Open No. 2007-102458, a feature amount extracted from each of many image examples is associated with a pre-processing method optimized for a corresponding image example and stored in advance. The apparatus extracts a similar feature amount from a new input image, selects a previously-stored image example based on the feature amount, and selects an optimized pre-processing method associated with the selected image example as a pre-processing method for the new input image.

However, such a conventional method in which a parameter is set based on the actual recognition performance is problematic in that an accurate result for each parameter needs to be prepared to obtain the recognition performance of each target. As a result, such a conventional method is quite costly.

In addition, in accordance with the method discussed in Japanese Patent Application Laid-Open No. 2007-102458, while an accurate result based on each pre-processing method does not need to be prepared, it is necessary to prepare an image similar to a target input image in order to set an appropriate pre-processing method. Thus, it is necessary to exhaustively prepare various image examples that are assumed to be input images, thereby requiring a significant data amount.

### SUMMARY OF THE INVENTION

The present invention(s) are directed to at least one information processing apparatus capable of setting appropriate one or more parameters for pattern recognition while requiring a reduced processing amount and a reduced memory capacity for processing, one or more information processing methods, and one or more computer-readable storage mediums.

According to an aspect of the present invention(s), an information processing apparatus includes a first setting unit configured to set at least one parameter candidate to be used for pattern recognition, a first feature data generation unit configured to generate at least one feature data of at least one image data obtained by using the at least one parameter candidate set by the first setting unit, a storage unit configured to store an estimation model which is a modelization of a relationship between at least one feature data of a plurality of image data obtained by using each of a plurality of model parameters and an evaluation value for each of the plurality of the model parameters, and an estimation unit configured to refer to the estimation model and estimate an evaluation value for each of the at least one parameter candidate based on each of the at least one feature data generated by the first feature data generation unit.

According to the present invention, it is possible to set appropriate one or more parameters for pattern recognition while requiring a reduced processing amount and a reduced memory capacity for processing.

Further features of the present invention will become apparent from the following description of exemplary embodiments with reference to the attached drawings.

### BRIEF DESCRIPTION OF THE DRAWINGS

FIG. 1 illustrates a pattern recognition apparatus according to a first exemplary embodiment.

FIG. 2 illustrates a hardware configuration of the pattern recognition apparatus according to the first exemplary embodiment.

FIG. 3 is a flowchart illustrating evaluation value estimation processing according to the first exemplary embodiment.

FIG. 4 is a flowchart illustrating pattern recognition processing according to the first exemplary embodiment.

FIG. 5 illustrates an estimation model generation apparatus according to the first exemplary embodiment.

FIG. 6 is a flowchart illustrating model generation processing according to the first exemplary embodiment.

FIG. 7 illustrates a pattern recognition apparatus according to a second exemplary embodiment.

FIG. 8 is a flowchart illustrating evaluation value estimation processing according to the second exemplary embodiment.

FIG. 9 illustrates an estimation model generation apparatus according to the second exemplary embodiment.

FIG. 10 is a flowchart illustrating model generation processing according to the second exemplary embodiment.

FIG. 11 illustrates a pattern recognition apparatus according to a third exemplary embodiment.

FIG. 12 is a flowchart illustrating evaluation value estimation processing according to the third exemplary embodiment.

FIG. 13 illustrates an estimation model generation apparatus according to the third exemplary embodiment.

FIG. 14 is a flowchart illustrating model generation processing according to the third exemplary embodiment.

### DESCRIPTION OF THE EMBODIMENTS

Various exemplary embodiments, features, and aspects of the invention will be described in detail below with reference to the drawings.

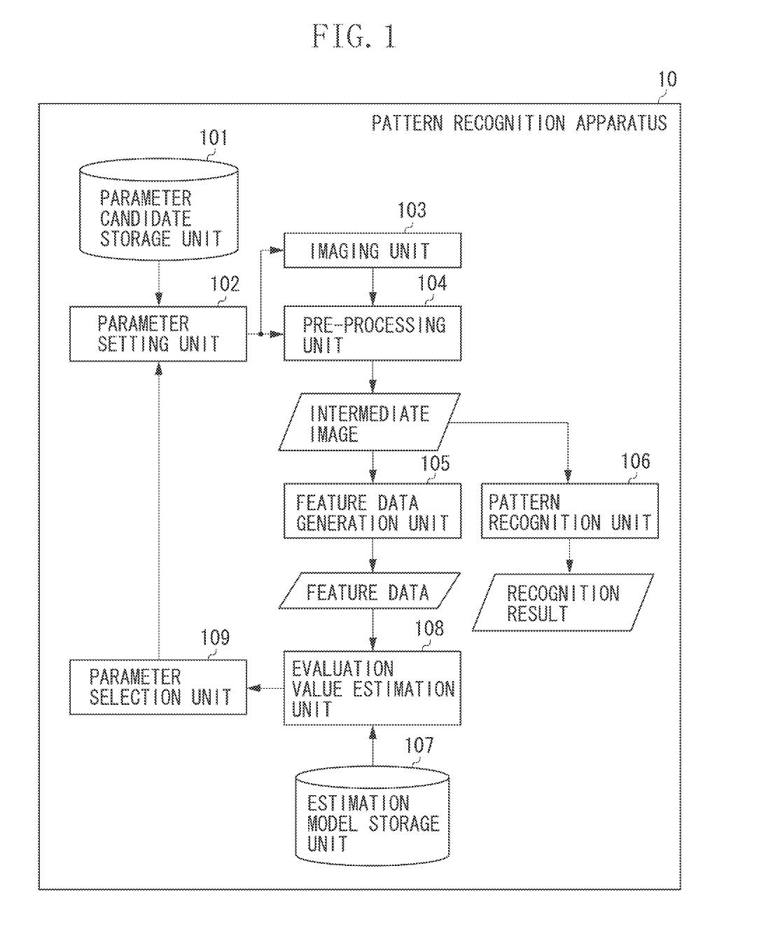

FIG. 1 illustrates a pattern recognition apparatus 10 as an information processing apparatus according to a first exemplary embodiment. The pattern recognition apparatus 10 performs pattern recognition on objects included in image data. The pattern recognition apparatus 10 according to the present exemplary embodiment uses image data of a pile of objects as targets and performs pattern recognition to estimate an approximate position and orientation of each object in the pile of objects.

In pattern recognition, it is possible to improve the recognition performance, for example, by appropriately setting imaging parameters for exposure time and pre-processing parameters a filter size for edge extraction for each target object, for example. The pattern recognition apparatus 10 according to the present exemplary embodiment evaluates the performance in pattern recognition per imaging parameter and pre-processing parameter, i.e., the recognition performance. Next, the pattern recognition apparatus 10 sets, based on the evaluation results, appropriate imaging and pre-processing parameters (use parameters). Next, the pattern recognition apparatus 10 actually performs pattern recognition based on the image data obtained by using the use parameters.

The pattern recognition apparatus 10 according to the present exemplary embodiment evaluates the recognition performance based on the imaging and pre-processing parameters without preparing accurate results by pattern recognition, i.e., answer values of an approximate position and orientation of each object in the pile of objects.

More specifically, first, the pattern recognition apparatus 10 actually performs imaging and pre-processing with various parameters and generates an intermediate image, which is an intermediate data, for each parameter. Next, the pattern recognition apparatus 10 extracts a predetermined number of feature amounts from each intermediate image and generates feature data.

Next, the pattern recognition apparatus 10 refers to estimation models and estimates, based on a plurality of feature data generated from each intermediate image, the recognition performance for each parameter. These estimation models are used for estimating the recognition performance from the feature data.

Next, a functional configuration of the pattern recognition apparatus 10 will be described with reference to FIG. 1. A parameter candidate storage unit 101 illustrated in FIG. 1 stores a plurality of parameter candidates. These parameter candidates are candidates of the parameters that can be used for pattern recognition. The parameter candidates according to the present exemplary embodiment include two kinds of candidates (i.e., imaging parameter candidates relating to imaging conditions and pre-processing parameter candidates relating to pre-processing). Thus, the parameter candidate storage unit 101 stores a plurality of imaging parameter candidates and a plurality of pre-processing parameter candidates.

Examples of the imaging parameter candidates include the exposure time and the amplifier gain. More specifically, an exposure time value such as 1 ms, 2 ms, 4 ms, . . . , 500 ms, or the like can be set as a parameter candidate.

Examples of the pre-processing parameter candidates include the size of a smoothing filter for noise removal and a coefficient for γ correction. The pre-processing parameter candidates are not limited to continuous values.

Examples of the pre-processing parameter candidates may include binarized values such as values indicating whether to perform bias correction. As another example, examples of the pre-processing parameter candidates may include multiple values indicating whether a Sobel filter, a Prewitt filter, or a Laplacian filter is used in edge extraction processing. As another example, examples of the pre-processing parameter candidates may include a value indicating the order of three processing of smoothing filter, γ correction, and edge extraction.

A parameter setting unit 102 reads imaging parameter candidates and pre-processing parameter candidates from the parameter candidate storage unit 101 and sets the read candidates in an imaging unit 103 and a pre-processing unit 104, respectively.

The imaging unit 103 captures an image by using the set imaging parameter candidates. The pre-processing unit 104 performs pre-processing on the image data obtained by the imaging unit 103, by using the set pre-processing parameter candidates and obtains an intermediate image as intermediate data.

A feature data generation unit 105 extracts a predetermined number of feature amounts from the intermediate image. More specifically, the feature data generation unit 105 extracts f feature amounts, i.e., feature amounts such as a luminance value average value, distribution, distortion, kurtosis, mode, and entropy of an intermediate image and a texture feature amount using a co-occurrence matrix. In addition, the feature data generation unit 105 generates a feature vector in which a plurality of extracted feature amounts is arranged in order as feature data.

The co-occurrence matrix is described in the following literature: Robert M. Haralick, K. Shanmugam, and Itshak Dinstein, “Texture Features for Image Classification”, IEEE Transactions on System, Man and Cybernatic, Vol. 6, pp. 610-621, 1973.

While the feature data generation unit 105 according to the present exemplary embodiment extracts feature amounts representing macro image properties from an intermediate image, it is not limited to such example. In other words, the kinds of feature amounts are not limited to those in the present exemplary embodiment, as long as the feature data generation unit 105 can generate feature amounts representing image properties.

An estimation model storage unit 107 stores estimation models. These estimation models are used for estimating evaluation values from feature data. Each evaluation value represents the recognition performance in pattern recognition on an intermediate image obtained by using set parameters.

An estimation model according to the present exemplary embodiment is a modelization of a relationship between a feature vector in which f feature amounts extracted from a model image are arranged and an evaluation value of the recognition performance in pattern recognition on a model image.

In the present exemplary embodiment, support vector regression (SVR) is used for the estimation models. SVR is described in the following literature: Alex J. Smola and Bernhard Scholkopf, “A Tutorial on Support Vector Regression”, Statistics and Computing, Vol. 14, No. 3, pp. 199-222, 2004.

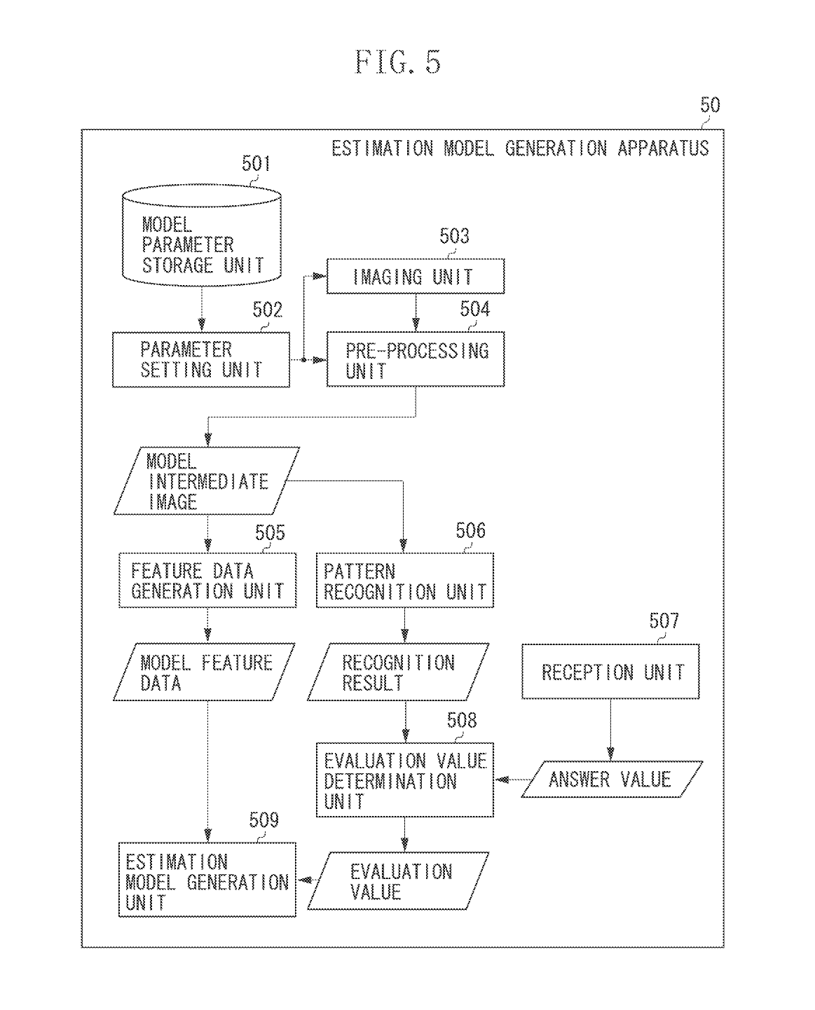

These estimation models according to the present exemplary embodiment are generated by an estimation model generation apparatus 50 and stored in the estimation model storage unit 107. The estimation model generation apparatus 50 will be described below with reference to FIG. 5.

An evaluation value estimation unit 108 refers to the estimation models, and based on the feature data generated by the feature data generation unit 105, estimates an evaluation value of the recognition performance in pattern recognition on the image data obtained by using the set parameter candidates. The evaluation value estimation unit 108 according to the present exemplary embodiment estimates an evaluation value for each of the parameter candidates set in the imaging unit 103 and the pre-processing unit 104.

Based on an evaluation value for each parameter estimated by the evaluation value estimation unit 108, a parameter selection unit 109 selects use parameters from the plurality of parameter candidates stored in the parameter candidate storage unit 101. In the present exemplary embodiment, the parameter selection unit 109 selects an imaging use parameter and a pre-processing use parameter.

A pattern recognition unit 106 performs pattern recognition processing based on the intermediate image obtained after an imaging use parameter and a pre-processing use parameter are set in the imaging unit 103 and the pre-processing unit 104, respectively. The pattern recognition unit 106 generates a recognition result which is obtained by pattern recognition and in which a plurality of candidate values of a general position and orientation of an object is arranged in descending order of recognition reliability and outputs the recognition result. Japanese Patent Application Laid-Open No. 2011-216087 discusses processing of the pattern recognition unit 106.

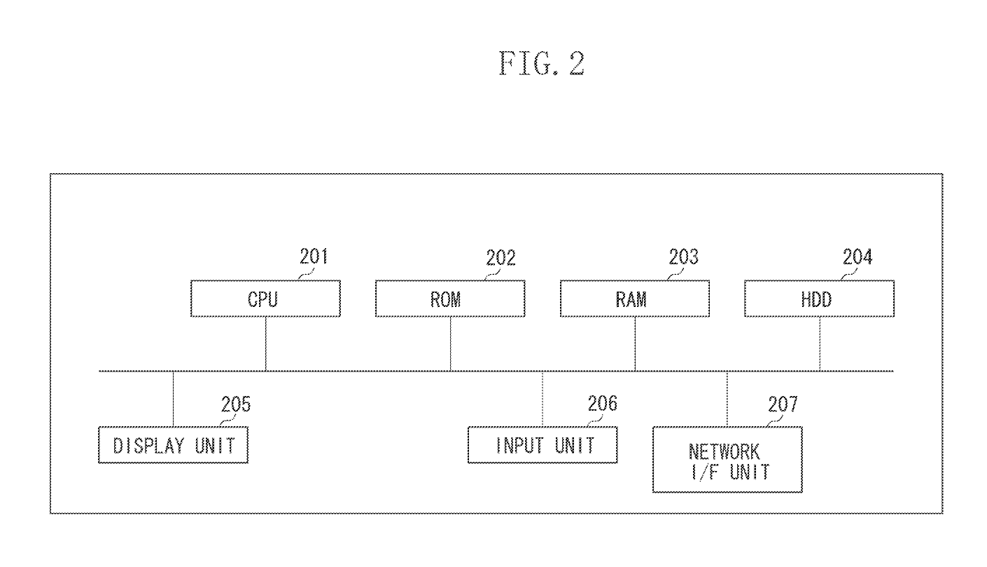

FIG. 2 illustrates a hardware configuration of the pattern recognition apparatus 10 according to the first exemplary embodiment. The pattern recognition apparatus 10 includes a central processing unit (CPU) 201, a read-only memory (ROM) 202, a random access memory (RAM) 203, a hard disk drive (HDD) 204, a display unit 205, an input unit 206, and a network interface (I/F) unit 207. The CPU 201 reads control programs stored in the ROM 202 and performs various types of processing.

The RAM 203 is used as a temporary storage area, serving as a main memory and a work area of the CPU 201. The HDD 204 stores various types of information such as image data and various types of programs. The display unit 205 displays various types of information. The input unit 206 includes a keyboard and/or a mouse to receive various types of user operations.

The network I/F unit 207 performs processing for communication with an external apparatus such as the estimation model generation apparatus via a network. Examples of the network include Ethernet (registered trademark). Alternatively, the network I/F unit 207 may be configured to communicate with an external apparatus wirelessly.

Functions and processing of the pattern recognition apparatus 10 are realized by the CPU 201 reading a program stored in the ROM 202 or the HDD 204 and executing this program.

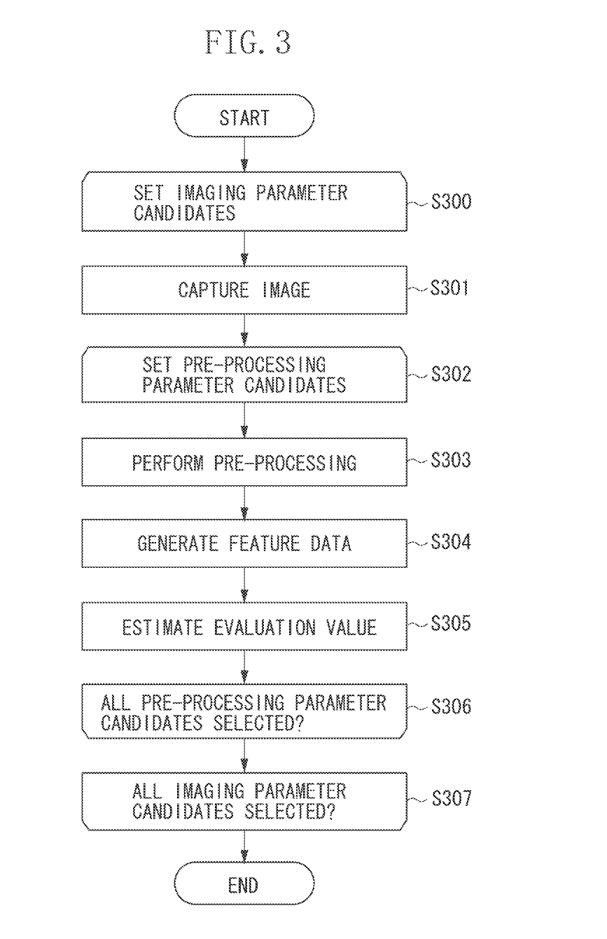

FIG. 3 is a flowchart illustrating evaluation value estimation processing performed by the pattern recognition apparatus 10. In step S300, the parameter setting unit 102 selects one combination of the plurality of imaging parameter candidates stored in the parameter candidate storage unit 101. In addition, the parameter setting unit 102 sets the selected combination of imaging parameter candidates in the imaging unit 103 (first setting processing). The processing from step S300 to step S307 are repeated. Each time the processing from step S300 to step S306 is repeated, the parameter setting unit 102 selects one unprocessed combination of imaging parameter candidates. Until the parameter setting unit 102 selects all the combinations of the imaging parameter candidates stored in the parameter candidate storage unit 101 in step S300, the processing from step S300 to step S307 is repeated.

The present exemplary embodiment assumes that the parameter candidate storage unit 101 stores Nt parameter candidates relating to the exposure time and Ng parameter candidates relating to the amplifier gain. In this case, in step S300, the parameter setting unit 102 sequentially sets “Nt×Ng” combinations as imaging parameter candidates. In other words, the processing from step S300 to step S307 is repeated “Nt×Ng” times.

In step S301, the imaging unit 103 captures an image of a pile objects on which pattern recognition is performed, by using the imaging parameter candidates set in step S300 (image capturing processing).

Next, in step S302, the parameter setting unit 102 selects one combination of the plurality of pre-processing parameter candidates stored in the parameter candidate storage unit 101. Next, the parameter setting unit 102 sets the selected combination of pre-processing parameter candidates in the pre-processing unit 104 (first setting processing).

The processing from step S302 to step S306 is repeated. Each time the processing from step S302 to step S306 is repeated, the parameter setting unit 102 selects one unprocessed combination of pre-processing parameter candidates. Until the parameter setting unit 102 selects all the combinations of the pre-processing parameter candidates in step S302, the processing from step S301 to step S306 is repeated.

The present exemplary embodiment assumes that the parameter candidate storage unit 101 stores Np combinations of pre-processing parameter candidates. In this case, in step S302, the parameter setting unit 102 sequentially sets the Np combinations of pre-processing parameter candidates and repeats the processing from step S302 to step S306 Np times.

In step S303, by using the pre-processing parameter candidates set in step S302, the pre-processing unit 104 performs pre-processing (image processing) on the image data to obtain an intermediate image. The image data on which the pre-processing is performed is the image data obtained by the image capturing processing performed in step S301. In addition, the intermediate image is an example of image data obtained after image processing.

Next, in step S304, the feature data generation unit 105 extracts a plurality of feature amounts from the intermediate image and generates a feature vector as feature data based on the extracted feature amounts (first feature data generation processing). Next, in step S305, the evaluation value estimation unit 108 refers to the estimation models stored in the estimation model storage unit 107 and estimates an evaluation value based on the feature data (estimation processing).

The evaluation value estimated in step S305 is for the imaging parameter candidates set in step S300 and the pre-processing parameter candidates set in step S302.

In step S306, the parameter setting unit 102 determines whether all the combinations of pre-processing parameter candidates have already been selected. If there is an unselected combination of pre-processing parameter candidates, the processing returns to step S302. In step S302, the parameter setting unit 102 selects the unselected combination of pre-processing parameter candidates and sets these candidates in the pre-processing unit 104.

In this way, since the parameter setting unit 102 repeats the processing from step S302 to step S306, the evaluation value estimation unit 108 can acquire an evaluation value for each combination of pre-processing parameter candidates set for one imaging parameter candidate.

In step S306, if the parameter setting unit 102 determines that all the combinations of pre-processing parameter candidates have already been selected, the processing proceeds to step S307.

In step S307, the parameter setting unit 102 determines whether all the combinations of imaging parameter candidates have already been selected. If there is an unselected combination of imaging parameter candidates (NO in step S307), the processing returns to step S300. In step S300, the parameter setting unit 102 selects the unselected combination of imaging parameter candidates and sets these candidates in the imaging unit 103. In step S307, if the parameter setting unit 102 determines that all the combinations of imaging parameter candidates have already been selected, the evaluation value estimation processing is ended.

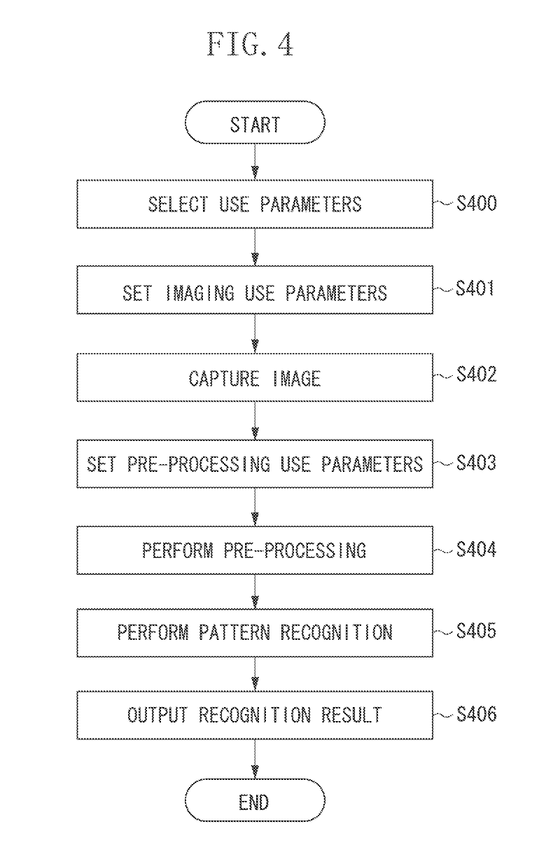

FIG. 4 is a flowchart illustrating pattern recognition processing performed by the pattern recognition apparatus 10. In step S400, the parameter selection unit 109 selects use parameters from the plurality of parameter candidates stored in the parameter candidate storage unit 101 (selection processing). Among the parameter candidates stored in the parameter candidate storage unit 101, the use parameters are optimum parameter candidates that can be used for image data used in pattern recognition processing. More specifically, the parameter selection unit 109 selects imaging parameter candidates and pre-processing parameter candidates that achieve a maximum evaluation value as imaging use parameters and pre-processing use parameters, respectively.

Next, in step S401, the parameter setting unit 102 sets the imaging use parameters in the imaging unit 103. Next, in step S402, by using the imaging use parameters set in step S401, the imaging unit 103 captures image data.

Next, in step S403, the parameter setting unit 102 sets the pre-processing use parameters in the pre-processing unit 104. Next, in step S404, by using the pre-processing use parameters set in step S403, the pre-processing unit 104 performs pre-processing on the image data to obtain an intermediate image.

Next, in step S405, the pattern recognition unit 106 performs pattern recognition processing on the intermediate image to obtain a recognition result. Next, in step S406, the pattern recognition unit 106 outputs the recognition result. Thus, the pattern recognition processing is ended.

In this way, since the pattern recognition apparatus 10 performs pattern recognition by using parameter candidates that achieve a maximum evaluation value as the use parameters in the pattern recognition processing, the pattern recognition performance can be improved.

In the present exemplary embodiment, the estimation models are stored in advance in the estimation model storage unit 107 in the pattern recognition apparatus 10. However, it is not limited to such example. In other words, modification s are possible as long as the evaluation value estimation unit 108 can refer to estimation models. For example, the pattern recognition apparatus 10 may receive estimation models from the outside.

Further alternatively, the parameter selection unit 109 may select a plurality of parameter candidates in descending order of evaluation. In such a case, the parameter setting unit 102 may use an average value of the plurality of parameter candidates as a use parameter.

FIG. 5 illustrates the estimation model generation apparatus 50 as an information processing apparatus. The estimation model generation apparatus 50 generates an estimation model based on each of the captured images of a plurality of piles of objects prepared by a user.

The estimation model generation apparatus 50 generates the estimation models stored in the estimation model storage unit 107 in the pattern recognition apparatus 10. Some of the functions of the estimation model generation apparatus 50 are the same as those of the pattern recognition apparatus 10. Hereinafter, functions of the estimation model generation apparatus 50 that are different from those of the pattern recognition apparatus 10 will be described.

As described above, the estimation model according to the present exemplary embodiment is a regression model for predicting the recognition performance in a recognition method performed based on a feature vector (feature data) in which a plurality of feature amounts extracted from an intermediate image is arranged, using the intermediate image.

To generate such a regression model, many combinations of an explanatory variable as an input and an objective variable as an output can be used. Thus, by using various objects, the estimation model generation apparatus 50 generates data including combinations of explanatory and objective variables and generates estimation models based on the generated data. In the present exemplary embodiment, feature data and an evaluation value respectively correspond to an explanatory variable and an objective variable.

A model parameter storage unit 501 stores a plurality of model parameters used for generating estimation models, i.e., the model parameter storage unit 501 stores model parameters for estimation models. The model parameters includes two kinds of parameters, which are imaging model parameters and pre-processing model parameters. The model parameters are the same as the parameter candidates stored in the parameter candidate storage unit 101 in the pattern recognition apparatus 10.

The parameter setting unit 502 corresponds to the parameter setting unit 102 in the pattern recognition apparatus 10. Likewise, an imaging unit 503, a pre-processing unit 504, a feature data generation unit 505, and a pattern recognition unit 506 correspond to the imaging unit 103, the pre-processing unit 104, the feature data generation unit 105, and the pattern recognition unit 106 in the pattern recognition apparatus 10, respectively. An intermediate image obtained by the pre-processing unit 504 will be referred to as a model intermediate image. In addition, feature data obtained by the feature data generation unit 505 will be referred to as model feature data.

A reception unit 507 receives answer values with respect to an object in the pile of objects. Answer values represent an approximate position and orientation of each object in the pile of objects. For example, answer values can be obtained by specifying positions of a plurality of predetermined portions of an object in an image obtained by capturing a pile of objects.

This processing for preparing answer values requires a large cost. However, the processing for preparing answer values is only necessary in a stage of generating estimation models, and it is only necessary to perform the processing only on some cases in this stage. In other words, once estimation models are generated, there is no need to individually prepare answer values for new targets. Thus, the cost for preparing answer values can be reduced.

In the present exemplary embodiment, the objects used for generating the estimation models do not include any target objects on which parameter evaluation is performed. If the objects used for generating the estimation models include a target object, the parameter evaluation may be performed by using the answer values of the approximate positions and orientations of the individual objects prepared when the estimation models are generated and estimating actual recognition performance.

The estimation model generation apparatus 50 has the same hardware configuration as that of the pattern recognition apparatus 10 (see FIG. 2).

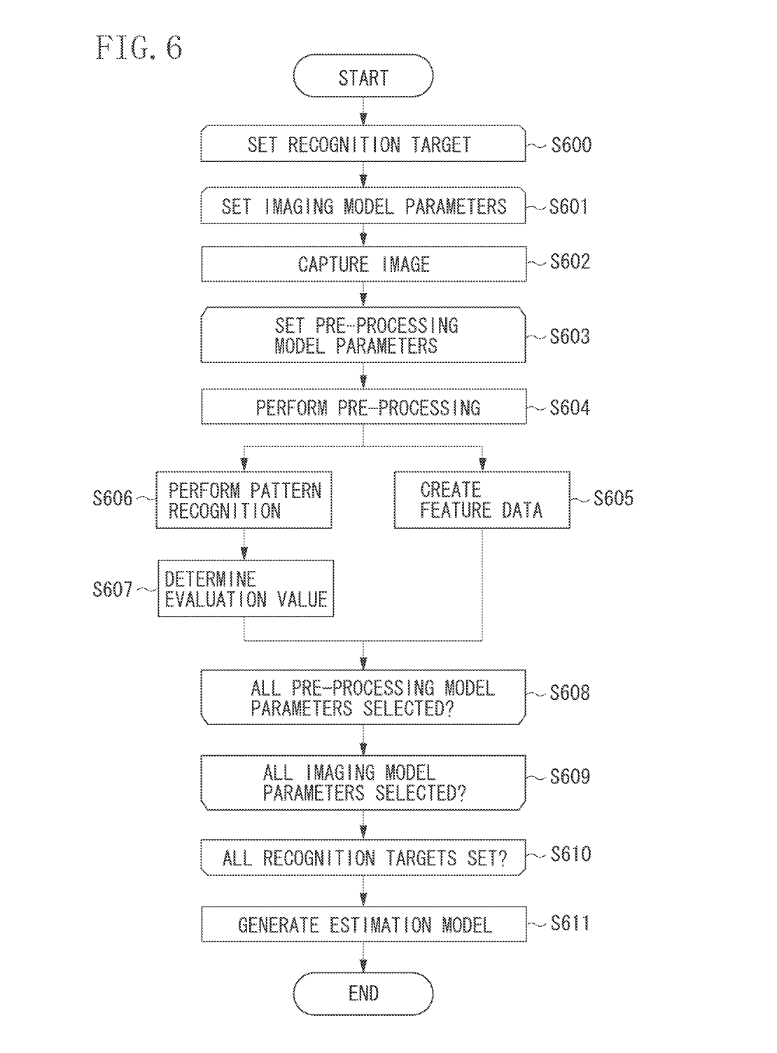

FIG. 6 is a flowchart illustrating model generation processing performed by the estimation model generation apparatus 50. In step S600, the reception unit 507 receives answer values. These answer values are for an image of a pile of objects prepared by the user. This pile of objects is the target to be captured in step S602. Therefore, in step S600, the reception unit 507 receives answer values for an image captured in step S602.

The processing from step S600 to step S610 is repeated. Each time the processing from step S600 to step S610 is repeated, a user or the like prepares a different pile of objects. Each time the processing from step S600 to step S610 is repeated, the reception unit 507 receives answer values for a different pile of objects in step S600.

In addition, in step S600, until the reception unit 507 receives answer values for all the piles of objects, the processing from step S600 to step S610 is repeated.

Next, in step S601, the parameter setting unit 502 selects one combination of the plurality of imaging model parameters stored in the model parameter storage unit 501. In addition, the parameter setting unit 502 sets the selected combination of imaging model parameters in the imaging unit 503 (second setting processing).

The processing from step S601 to step S609 is repeated. Each time the processing from step S601 to step S609 is repeated, the parameter setting unit 102 selects one unprocessed combination of imaging model parameters. In step S601, until the parameter setting unit 502 selects all the combinations of imaging model parameters, the processing from step S601 to step S609 is repeated.

In step S602, the imaging unit 503 captures an image of the pile of objects. Next, in step S603, the parameter setting unit 502 selects one combination of the plurality of pre-processing model parameters stored in the model parameter storage unit 501. In addition, the parameter setting unit 502 sets the selected combination of pre-processing model parameters in the pre-processing unit 504 (second setting processing).

The processing from step S603 to step S608 is repeated. Each time the processing from step S603 to step S608 is repeated, the parameter setting unit 502 selects one unprocessed combination of pre-processing model parameters. In step S603, until the parameter setting unit 502 selects all the combinations of pre-processing parameters, the processing from step S603 to step S608 is repeated.

Next, in step S604, by using the pre-processing model parameters set in step S603, the pre-processing unit 104 performs pre-processing on the model image data captured in step S602 and obtains a model intermediate image. The model intermediate image is an example of model image data used for generating an estimation model.

Next, in step S605, the feature data generation unit 505 extracts a plurality of feature amounts from the model intermediate image, and based on the extracted feature amounts, generates a feature vector as model feature data (second feature data generation processing).

In addition, in step S606, the pattern recognition unit 506 performs pattern recognition processing on the model intermediate image to obtain a recognition result. For example, the pattern recognition unit 506 performs pattern recognition processing discussed in Japanese Patent Application Laid-Open No. 2011-216087, obtains a plurality of candidates of an approximate position and orientation of an object, and arranges the plurality of candidates in descending order of recognition reliability.

Next, in step S607, based on the recognition result obtained in step S606 and the answer values received by the reception unit 507 in step S600, an evaluation value determination unit 508 determines a recognition performance evaluation value for the set model parameters.

More specifically, if the difference between the recognition result and the answer values is less than or equal to a threshold, the evaluation value determination unit 508 determines that the recognition is succeeded. The present exemplary embodiment assumes that the threshold is previously set in the HDD 204 or the like. For example, the threshold can be represented by a combination of the number of pixels deviated from respective approximate positions and the angle of deviation in orientation.

The evaluation value determination unit 508 calculates a precision and a recall for each candidate. The evaluation value determination unit 508 calculates an average precision, which is an average of precisions per recall, and determines this to be a recognition performance evaluation value.

In processing from step S605 to step S607, a combination of one model feature data (explanatory variable) for one pile of objects and one evaluation value (objective variable) indicating a model recognition performance is generated. The estimation model generation unit 509 acquires the combination of feature data and the evaluation value.

In step S608, the parameter setting unit 502 determines whether all the combinations of pre-processing model parameters have already been selected. If an unselected combination of pre-processing model parameters exists (NO in step S608), the processing returns to step S603. On the other hand, if there is not any unprocessed combination of pre-processing model parameters (YES in step S608), the processing proceeds to step S609.

In this way, a combination of feature data and an evaluation value is generated for each combination of the plurality of pre-processing model parameters for each combination of imaging model parameters for each pile of objects prepared.

In step S609, the parameter setting unit 502 determines whether all the combinations of imaging model parameters have already been selected. If an unselected combination of imaging model parameters exists (NO in step S609), the processing returns to step S601. On the other hand, if no unprocessed imaging model parameter exists (YES in step S609), the processing proceeds to step S610. In this way, the above combination is generated for each of the plurality of imaging model parameters for one prepared pile of objects.

For example, if Nc combinations of imaging model parameters and Np combinations of pre-processing model parameters exist, “Nc×Np” combinations of feature data and an evaluation value are generated for one pile of objects. All the obtained combinations of feature data and an evaluation value are transmitted to the estimation model generation unit 509. Thus, the processing for one pile of objects prepared is ended.

In addition, until the CPU 201 completes the processing on all the piles of objects, the processing from step S600 to step S610 is repeated.

In step S611, the estimation model generation unit 509 generates an SVR model as an estimation model based on the plurality of combinations of feature data and an evaluation value obtained through the repetitive processing from step S600 to step S610 (model generation processing). Thus, the estimation model generation processing is ended.

The estimation model generation apparatus 50 according to the present exemplary embodiment performs the repetitive processing from step S600 to step S610 on a preset number of piles of objects. It is desirable that the number of piles of objects be large. However, a relatively small number of piles of objects, such as 10 or 20 piles of objects, may be set.

For example, if the number of piles of objects is Ny, the number of combinations of imaging model parameters is Nc, the number of combinations of pre-processing model parameters is Np, “Ny×Nc×Np” combinations of feature data and an evaluation value is generated in the processing from step S600 to step S610. For example, if Ny=10, Nc=15, and Np=1,000, 150,000 (10×15×1,000) combinations are generated.

As described above, the estimation model generation apparatus 50 according to the present exemplary embodiment uses many combinations of data, uses a regression function in which feature data is used as an explanatory variable and an evaluation value is used as an objective variable, and generates an SVR regression function model as an estimation model. The pattern recognition apparatus 10 uses an estimation model generated by the estimation model generation apparatus 50 to estimate a parameter candidate evaluation value.

Thus, the pattern recognition apparatus 10 can perform parameter evaluation more appropriately, compared with a method in which parameter evaluation is performed on a rule basis based on conditions of extracted feature amounts, for example.

In addition, by the estimation model generation apparatus 50 generating estimation models based on intermediate images obtained by using many parameters, the possibility that an image example (intermediate image) similar to a pattern recognition target image exists can be increased. Therefore, even when the estimation model generation apparatus 50 generates an estimation model from an image that is not similar to a pattern recognition target image, the estimation model generation apparatus 50 can generate an estimation model capable of estimating an evaluation value accurately based on various images.

In addition, the estimation model generation apparatus 50 generates estimation models by using not only optimum cases but also cases with low recognition performance. Thus, by using generated estimation models, the possibility that the recognition performance level can relatively be evaluated is increased. Thus, the pattern recognition apparatus 10 can estimate valid recognition performance based on new target feature data.

A first modification of the first exemplary embodiment will be described. The estimation models are not limited to SVR regression function models. Alternatively, the estimation models may be Bagging Trees or the like. Bagging Trees is described in Leo Breiman, “Bagging Predictors”, Machine Learning, Vol. 24, No. 2, pp. 123-140, 1996.

In addition, a second modification will be described. The estimation models are not limited to regression models. For example, a model that enables a binary determination, such as a model representing that the recognition will succeed or fail may be used.

In addition, a third modification will be described. The pattern recognition processing is not limited to that described in the exemplary embodiment. Alternatively, general pattern matching may be used in the pattern recognition processing. However, the pattern recognition processing by the pattern recognition apparatus 10 and the estimation model generation apparatus 50 needs to include the same processing content.

Next, a fourth modification will be described. While the estimation model generation apparatus 50 according to the present exemplary embodiment uses an average precision as an objective function, the present invention is not limited to such an example. Alternatively, the estimation model generation apparatus 50 may use an f value or the like for a recognition result up to a predetermined number. Therefore, specific values are not limited to those described in the exemplary embodiment, as long as the estimation model generation apparatus 50 uses an index that represents recognition performance.

Next, a fifth modification will be described. While the estimation model generation apparatus 50 according to the present exemplary embodiment obtains an evaluation value as an objective variable based on an image of one pile of objects, the present invention is not limited to such an example. Alternatively, the estimation model generation apparatus 50 may obtain an evaluation value based on an image of each of a plurality of piles of objects.

For example, the estimation model generation apparatus 50 may capture images of a pile of objects in Nt ways per object (e.g., 10 ways) and obtain an average precision for each image. In such a case, the estimation model generation apparatus 50 can use an average of the Nt average precisions which are the same parameters as an evaluation value, for example.

In such a case, the number of explanatory variables corresponding to evaluation values as objective variables, i.e., the number of feature data generated from intermediate images, is Nt. Thus, it is only necessary that the estimation model generation apparatus 50 treats the objective variables corresponding to the respective feature data as the obtained evaluation values. Therefore, it is only necessary that the estimation model generation apparatus 50 generates Nt combinations of data in which the same evaluation values are used as objective variables.

Next, a sixth modification will be described. The evaluation target parameters according to the present exemplary embodiment are two kinds of parameters, which are imaging parameters and pre-processing parameters. However, the kinds of parameters and the number of parameters are not limited to those described in the exemplary embodiment. Alternatively, either imaging parameters or pre-processing parameters may be used as the evaluation target parameters.

Next, a seventh modification will be described. The pattern recognition apparatus 10 may be configured to function as the estimation model generation apparatus 50. In such case, in addition to the functional configuration illustrated in FIG. 1, the pattern recognition apparatus 10 further includes the reception unit 507, the evaluation value determination unit 508, and the estimation model generation unit 509 illustrated in FIG. 5.

Next, a pattern recognition apparatus 11 and an estimation model generation apparatus 51 according to a second exemplary embodiment will be described. The pattern recognition apparatus 11 and the estimation model generation apparatus 51 according to the second exemplary embodiment differ from the pattern recognition apparatus 10 and the estimation model generation apparatus 50 according to the first exemplary embodiment. Hereinafter, such differences will be described.

The pattern recognition apparatus 11 according to the present exemplary embodiment performs pattern recognition based on a captured image of an inspection target object to recognize whether a defect exists on a surface of the object. The pattern recognition apparatus 11 according to the present exemplary embodiment performs evaluation on parameters relating to illumination used during imaging, in addition to on imaging and pre-processing parameters for pattern recognition. The pattern recognition apparatus 11 according to the present exemplary embodiment uses captured images of objects having no defects in parameter evaluation.

In addition, the pattern recognition apparatus 11 according to the present exemplary embodiment sets illumination, imaging, and pre-processing use parameters, performs pattern recognition based on the image data obtained by using the use parameters, and detects a defect.

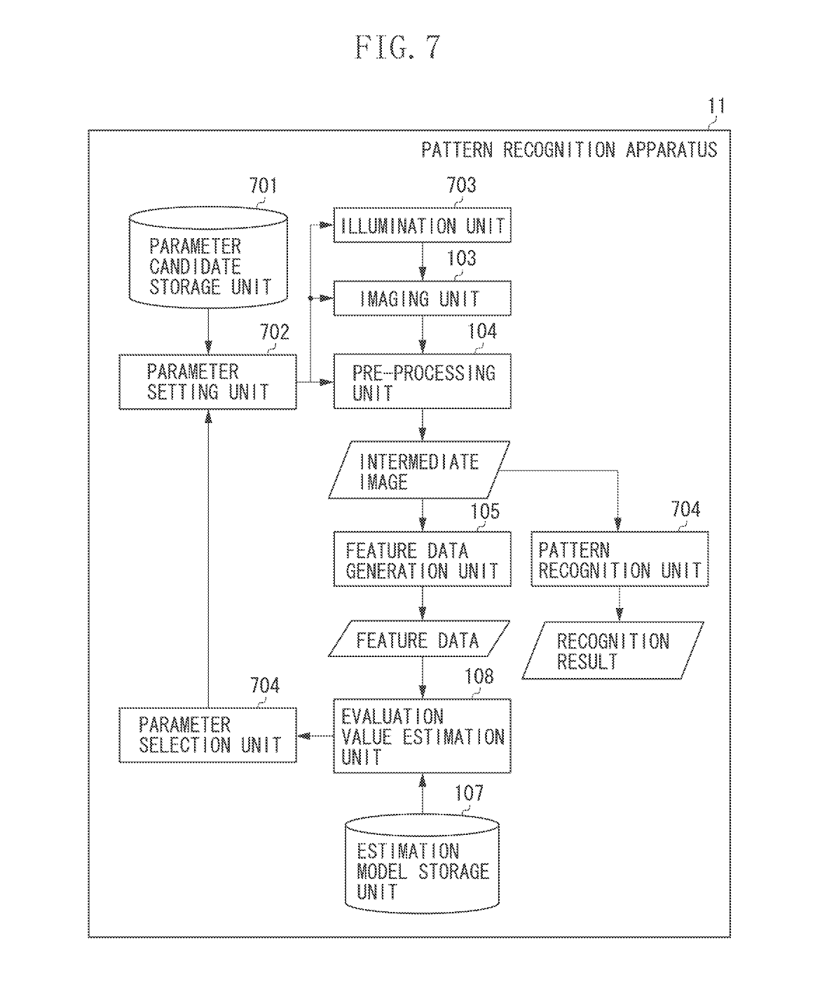

FIG. 7 illustrates a functional configuration of the pattern recognition apparatus 11 according to the second exemplary embodiment. Some of the functions of the pattern recognition apparatus 11 are the same as those of the pattern recognition apparatus 10 according to the first exemplary embodiment. Thus, the same functions are denoted by the same reference numerals.

A parameter candidate storage unit 701 illustrated in FIG. 7 stores a plurality of parameter candidates. The parameter candidates according to the present exemplary embodiment include three kinds of candidates, which are imaging parameter candidates, pre-processing parameter candidates, and illumination parameter candidates relating to illumination. Examples of the illumination parameter candidates include the brightness, the wavelength of illumination light, and the incidence angle on an inspection target object.

A parameter setting unit 702 reads imaging parameters, pre-processing parameters, and illumination parameters from the parameter candidate storage unit 701 and sets these parameters in an imaging unit 103, a pre-processing unit 104, and an illumination unit 703, respectively.

The illumination unit 703 is an illumination system for illuminating an inspection target object. A parameter selection unit 705 selects use parameter candidates from the plurality of parameter candidates stored in the parameter candidate storage unit 701 based on an evaluation value for each combination of parameters, estimated by an evaluation value estimation unit 108. The parameter selection unit 705 according to the present exemplary embodiment selects imaging use parameters, pre-processing use parameters, and illumination use parameters.

A pattern recognition unit 704 detects a defect based on an intermediate image obtained after the imaging use parameters, the pre-processing use parameters, and the illumination use parameters are set in the imaging unit 103, the pre-processing unit 104, and the illumination unit 703, respectively.

The estimation models stored in an estimation model storage unit 107 according to the present exemplary embodiment are regression models for predicting recognition performance based on feature data generated from an intermediate image of a non-defective object among the inspection target objects. In other words, an estimation model according to the present exemplary embodiment is a regression model in which data generated from an intermediate image of a non-defective object is used as an explanatory variable and the recognition performance is used as an objective variable.

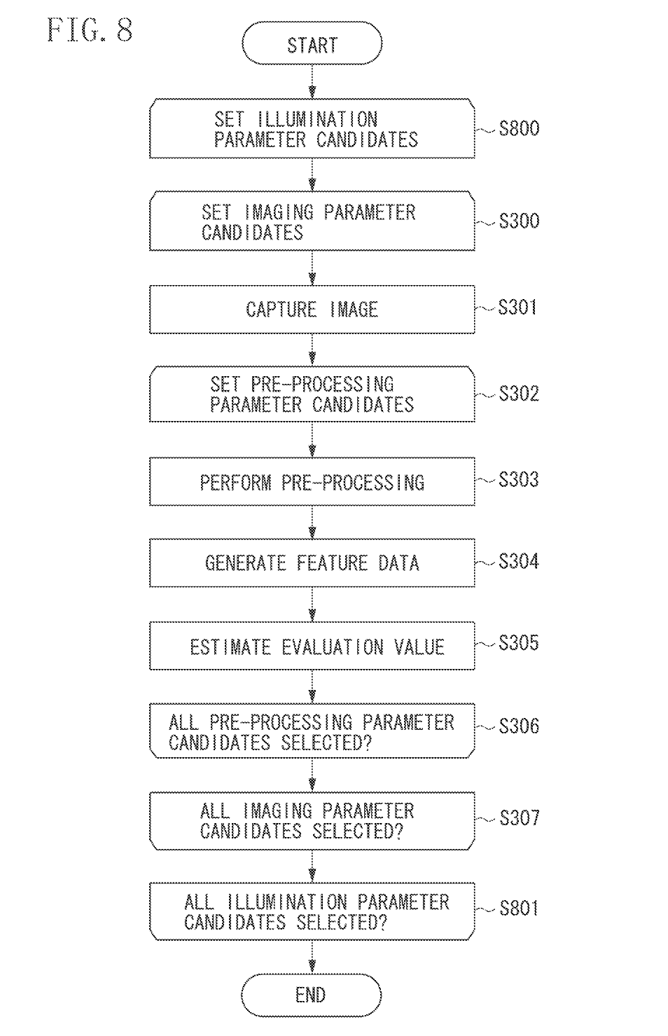

FIG. 8 is a flowchart illustrating evaluation value estimation processing performed by the pattern recognition apparatus 11. In step S800, the parameter setting unit 702 selects one combination of illumination parameter candidates from the plurality of illumination parameter candidates stored in the parameter candidate storage unit 701 and sets the selected combination of illumination parameter candidates in the illumination unit 703. Next, the processing proceeds to step S300.

The processing from step S800 to step S801 is repeated. Each time the processing from step S800 to step S801 is repeated, the parameter setting unit 702 selects an unprocessed combination of illumination parameter candidates. Until the parameter setting unit 702 selects all the combinations of illumination parameter candidates in step S800, the processing from step S800 to step S801 is repeated.

Other processing in the evaluation value estimation processing according to the second exemplary embodiment is the same as that according to the first exemplary embodiment.

The parameter candidate storage unit 701 stores Na parameter candidates relating to the brightness, NA parameter candidates relating to the wavelength, and NO parameter candidates relating to the incidence angle. In such a case, in step S800, the parameter setting unit 702 sequentially sets “Na×N∥×Nθ” combinations as illumination parameter candidates. Therefore, the processing from step S800 to step S801 is repeated “Na×Nλ×Nθ” times.

In the evaluation value estimation processing according to the present exemplary embodiment, the imaging unit 103 captures an image of a non-defective object among the inspection target objects in step S301.

Thus, the pattern recognition apparatus 11 according to the present exemplary embodiment can perform evaluation on the parameters relating to illumination. In addition, since the pattern recognition apparatus 11 selects the use parameters by using an evaluation result, the pattern recognition apparatus 11 can accurately detect presence of a defect on an object.

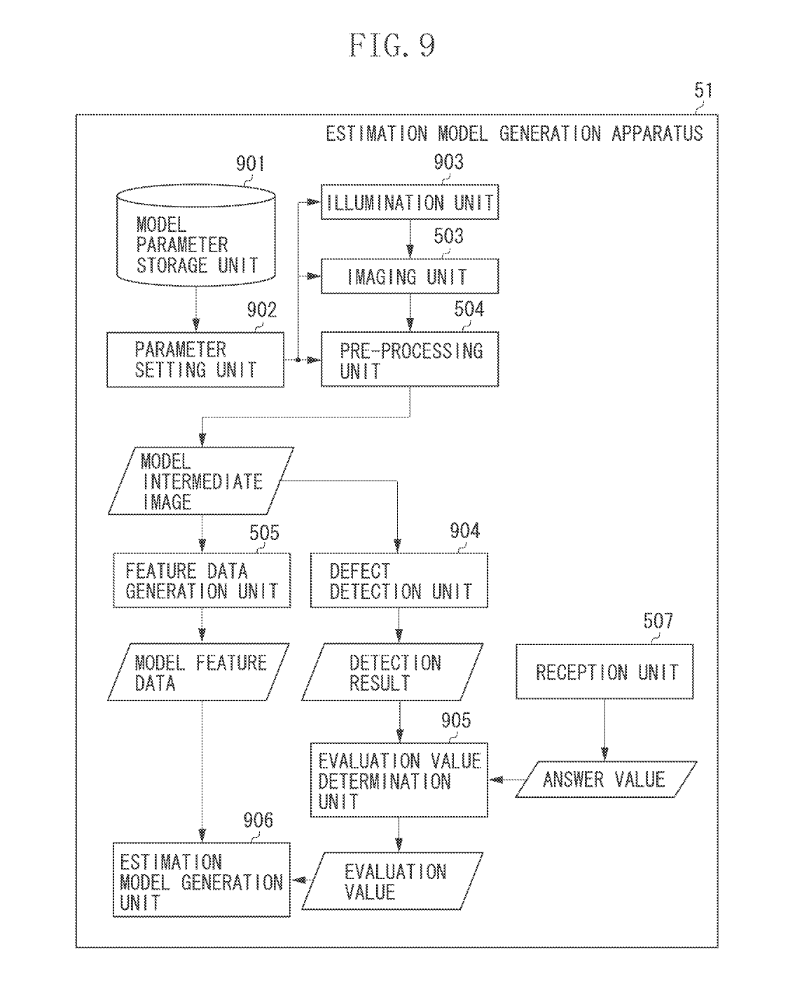

FIG. 9 illustrates a functional configuration of the estimation model generation apparatus 51 according to the second exemplary embodiment. Some of the functions of the estimation model generation apparatus 51 are the same as those of the estimation model generation apparatus 50 according to the first exemplary embodiment. Thus, the same functions are denoted by the same reference numerals.

The estimation model generation apparatus 51 generates an estimation model based on a captured image of each of the objects included in each of a plurality of object sets prepared by a user. Each object set includes one kind of objects including a plurality of non-defective objects and a plurality of defective objects. A plurality of object sets is sets of non-defective objects and defective objects of different kinds. An intermediate image of a defective object is used for obtaining recognition performance (an evaluation value), which is an objective variable. Therefore, the estimation model generation apparatus 51 does not extract a feature vector from an intermediate image of a defective object.

A model parameter storage unit 901 in the estimation model generation apparatus 51 illustrated in FIG. 9 stores a plurality of model parameters. The model parameters include three kinds of parameters, which are imaging model parameters, pre-processing model parameters, and illumination model parameters. The model parameters are the same parameters as the parameter candidates stored in the parameter candidate storage unit 701 in the pattern recognition apparatus 11.

A parameter setting unit 902 and an illumination unit 903 are respectively the same as the parameter setting unit 702 and the illumination unit 703 illustrated in FIG. 7. A defect detection unit 904 detects an image of a defective object from a model intermediate image by performing pattern recognition.

An evaluation value determination unit 905 determines an evaluation value based on a detection result obtained by the defect detection unit 904 and an answer value received by a reception unit 507. Each answer value received by the reception unit 507 according to the present exemplary embodiment is information indicating that an inspection target object to be captured is a non-defective object or a defective object.

An estimation model generation unit 906 generates an SVR regression function model as an estimation model based on the model feature data generated by a feature data generation unit 505 and the evaluation values determined by the evaluation value determination unit 905.

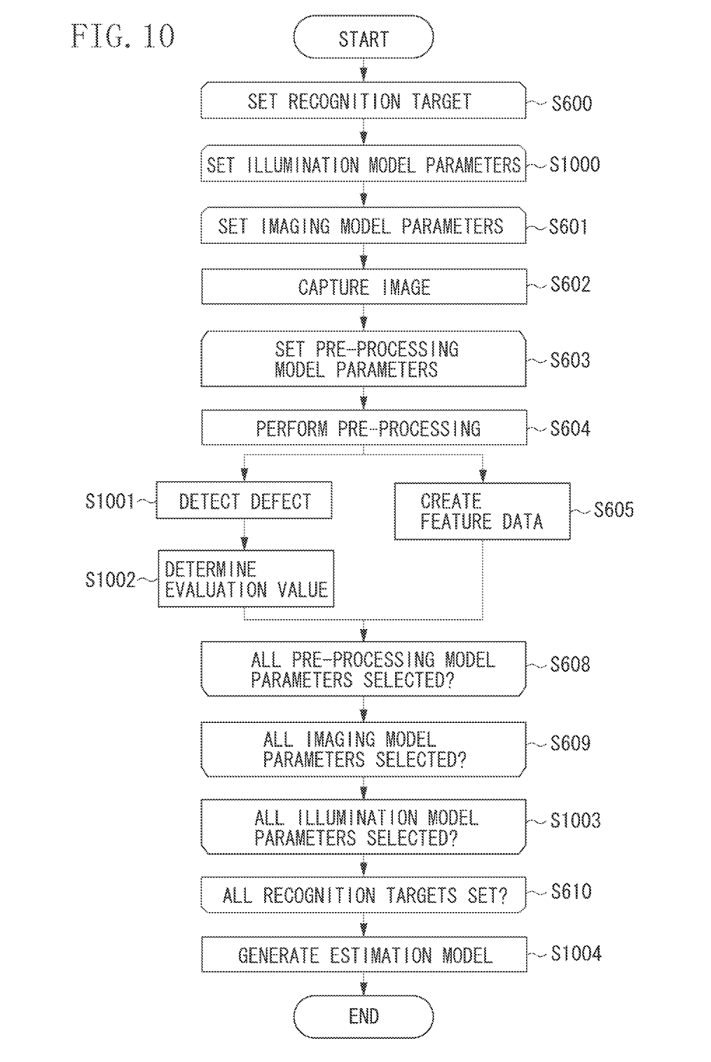

FIG. 10 is a flowchart illustrating model generation processing performed by the estimation model generation apparatus 51. Before the model generation processing according to the present exemplary embodiment is started, a user prepares a plurality kinds of object sets.

In the model generation processing, the estimation model generation apparatus 51 generates data including feature vectors generated from intermediate images of non-defective objects and evaluation values determined from intermediate images of non-defective objects and defective objects as combinations and generates estimation models based on the generated data.

In step S600, the reception unit 507 receives an answer value indicating that an inspection target object to be captured is a non-defective object or a defective object. Then, the processing proceeds to step S1000. If the inspection target object to be captured is a non-defective object, the user inputs an answer value indicating that the object is a non-defective object. If the inspection target object is a defective object, the user inputs an answer value indicating that the object is a defective object.

The processing from step S600 to step S610 is repeated. Each time the processing from step S600 to step S610 is repeated, the reception unit 507 receives an answer value for a different object for generating an estimation model. Until the reception unit 507 receives answer values for all the objects in step S600, the processing from step S600 to step S610 is repeated.

For example, assuming that Ns kinds of objects for generating an estimation model exist and that Nok non-defective objects and Nng defective objects exist for each kind, each of the Nok non-defective objects and the Nng defective objects of one object type is set sequentially in an imaging range as an imaging target. Accordingly, in step S600, the reception unit 507 receives an answer value corresponding to each of the Nok non-defective objects and the Nng defective objects.

The estimation model generation apparatus 51 performs the processing from step S1000 to step S1003 on each of the objects (non-defective objects and defective objects) included in each kind of object sets. The estimation model generation apparatus 51 according to the present exemplary embodiment processes the Nok non-defective objects first and on the Nng defective objects next.

In step S1000, the parameter setting unit 902 selects one combination of illumination model parameters from the plurality of illumination model parameters stored in the model parameter storage unit 901. In addition, the parameter setting unit 902 sets the selected combination of illumination model parameters in the illumination unit 903.

The processing from step S1000 to step S1003 is repeated. Each time the processing from step S1000 to step S1003 is repeated, the parameter setting unit 902 selects one unprocessed combination of illumination model parameters. In addition, step S1000, until the parameter setting unit 902 selects all the combinations of illumination model parameters, the processing from step S1000 to step S1003 is repeated.

In step S604, pre-processing is performed. Next, the processing proceeds to step S605. In step S605, the feature data generation unit 505 generates feature data from the model intermediate image obtained by the pre-processing. In the present exemplary embodiment, step S605 is performed only when the imaging target object is a non-defective object. This is to generate an estimation model by using a feature vector extracted from a non-defective object as an explanatory variable, as described above.

After the pre-processing performed in step S604, in step S1001, the defect detection unit 904 detects an image of a defective object from the model intermediate image. For example, the defect detection unit 904 detects an image of a defective object in accordance with a pattern recognition method discussed in Japanese Patent Application Laid-Open No. 2010-079272.

Next, in step S1002, the evaluation value determination unit 905 determines an evaluation value for the set model parameters based on presence or absence of an image of a defective object and on the answer value. More specifically, if an image of a defective object is detected while the answer value indicates a non-defective object, the evaluation value determination unit 905 determines that this is a failure case. If an image of a defective object is not detected while the answer value indicates a defective object, the evaluation value determination unit 905 also determines that this is a failure case. In the repetitive processing from step S600 to step S610, the evaluation value determination unit 905 determines the number of failure cases per object kind and determines the number to be an evaluation value per object kind for one combination of model parameters.

Steps S1001 and S1002 are performed regardless of whether the imaging target object is a defective object. After step S609, the processing proceeds to step S1003. In step S1003, the CPU 201 determines whether the processing from step S601 to step S609 is repeated on all the combinations of illumination model parameters. Then, the processing proceeds to step S610.

In this way, through the processing from step S600 to step S610 in the model generation processing according to the present exemplary embodiment, non-defective feature data and a failure case number (evaluation value) are obtained for one kind of objects.

For example, when Nok non-defective objects and Nng defective objects exist for each model parameter candidate set for one kind of objects, Nok feature data and the number of failure cases (evaluation value) are obtained. The combinations of data including feature data and evaluation values are transmitted to the estimation model generation unit 906. The feature data and the number of failure cases correspond to an explanatory variable and an objective variable, respectively.

For example, assuming that the number of kinds of objects is Ns, the number of non-defective objects is Nok, and the number of model parameter candidates is Nx, the number of combinations of the feature data and the failure case number is “Ns×Nx×Nok”. Thus, when Ns=10, Nx=2,000, and Nok=100, 2,000,000 (10×2,000×100) combinations are obtained.

In step S1004, the estimation model generation unit 906 generates SVR regression function models as estimation models based on the combinations of evaluation values and feature data.

In this way, the estimation model generation apparatus 51 according to the second exemplary embodiment is compatible with the pattern recognition apparatus 11 and generates estimation models based on intermediate images obtained by using a plurality of parameters including illumination parameters.

An estimation model evaluation value according to the present exemplary embodiment is the number of failure cases. Thus, by selecting parameter candidates producing a minimum evaluation value as the use parameters, the compatible pattern recognition apparatus 11 can accurately detect defects.

Other configurations and processing of the pattern recognition apparatus 11 and the estimation model generation apparatus 51 according to the second exemplary embodiment are similar to those of the pattern recognition apparatus 10 and the estimation model generation apparatus 50 according to the first exemplary embodiment.

A modification of the second exemplary embodiment will be described. The pattern recognition apparatus 11 may estimate an evaluation value of each of a plurality of parameter candidates not only for a single non-defective object but also for each of a plurality of non-defective objects. In such case, the pattern recognition apparatus 11 evaluates each parameter candidate based on an average value of the obtained evaluation values.

Next, a pattern recognition apparatus 12 and an estimation model generation apparatus 52 according to a third exemplary embodiment will be described. The pattern recognition apparatus 12 and the estimation model generation apparatus 52 according to the third exemplary embodiment differ from the pattern recognition apparatuses and the estimation model generation apparatuses according to the above exemplary embodiments in the following aspects. Hereinafter, such differences will be described.

The pattern recognition apparatus 12 according to the present exemplary embodiment performs pattern recognition and detects an abnormality within a monitoring area based on a moving image captured by a monitoring camera. More specifically, as in the pattern recognition apparatuses according to the above exemplary embodiments, the pattern recognition apparatus 12 according to the present exemplary embodiment sets use parameters after performing parameter evaluation and detects an abnormality based on a moving image obtained by using the use parameters.

The pattern recognition apparatus 12 according to the present exemplary embodiment uses a moving image previously determined to have no abnormality in parameter evaluation. Hereinafter, a moving image captured in a scene where no abnormality is caused will be referred to as a normal moving image and a moving image captured in a scene where an abnormality is caused will be an abnormal moving image.

According to the above exemplary embodiments, the pattern recognition is performed based on intermediate images and the parameter evaluation value estimation is performed based on feature data. In contrast, according to the present exemplary embodiment, both the parameter evaluation value estimation and the pattern recognition are performed based on feature data.

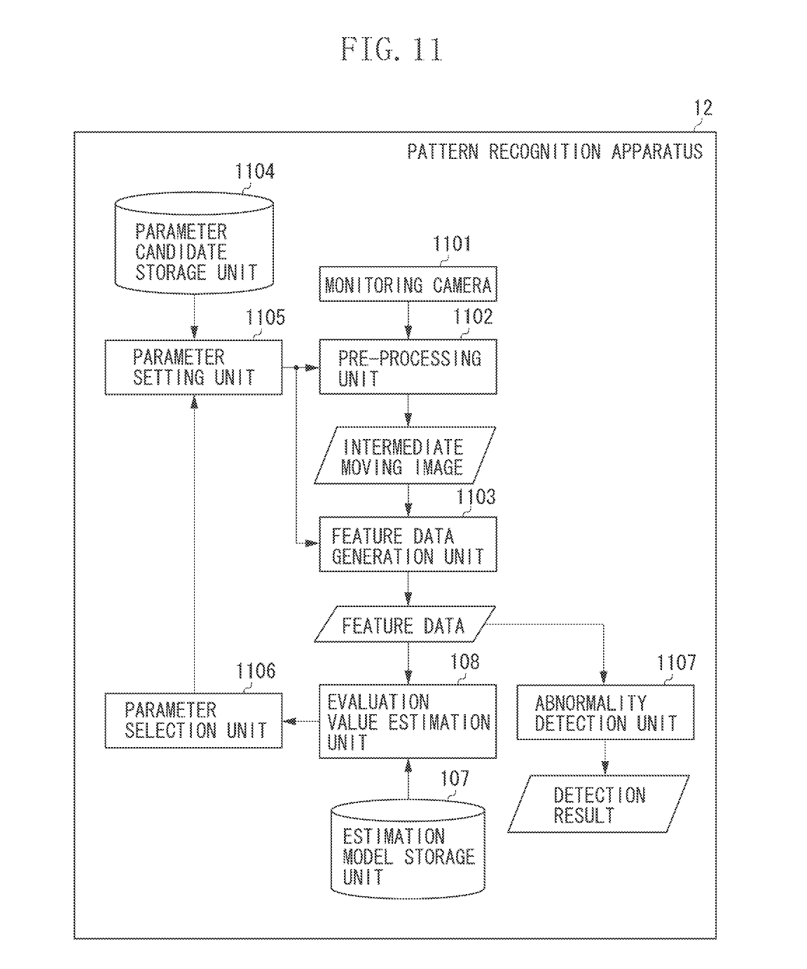

FIG. 11 illustrates a functional configuration of the pattern recognition apparatus 12 according to the third exemplary embodiment. Some of the functions of the pattern recognition apparatus 12 are the same as those of the pattern recognition apparatus 10 according to the first exemplary embodiment. Thus, the same functions are denoted by the same reference numerals.

A monitoring camera 1101 captures a moving image in a monitoring area. When performing parameter evaluation value estimation processing, the monitoring camera 1101 captures a moving image in a scene where no abnormality is caused. A pre-processing unit 1102 obtains an intermediate moving image by using a threshold for each frame of a moving image and performing binarization processing on a pixel value.

In addition, a feature data generation unit 1103 performs extraction of second-order cubic higher order local auto correlation (CHLAC) and generates a feature vector as feature data. In the present exemplary embodiment, the feature data generation unit 1103 performs extraction of a second-order CHLAC on a binarized moving image. Thus, a feature vector as feature data is a 251-order vector.

Extraction of CHLAC is described in Japanese Patent Application Laid-Open No. 2006-079272. Regarding extraction of CHLAC, a mask width (displacement width) in each of the spatial direction and the time direction and an integration range may be desirably set appropriately. This respect is described in Takuya NANRI and Nobuyuki OTSU, “Detection of Abnormal Motion from a Scene Containing Multiple Persons' Moves”, Information Processing Society of Japan Transactions, Computer Vision and Image Media, Vol. 46, pp. 43-50, 2005.

A parameter candidate storage unit 1104 stores a plurality of parameter candidates. In the present exemplary embodiment, the parameter candidates include two kinds of candidates, which are pre-processing parameter candidates and feature parameter candidates relating to generation of feature data. Examples of the feature parameter candidates include the mask width in each of the spatial direction and the time direction and the integration range.

A parameter setting unit 1105 reads pre-processing parameter candidates and feature parameter candidates from the parameter candidate storage unit 1104 and sets the read candidates in the pre-processing unit 1102 and the feature data generation unit 1103, respectively.

A parameter selection unit 1106 selects use parameter candidates from the plurality of parameter candidates stored in the parameter candidate storage unit 1104 based on a parameter evaluation value estimated by an evaluation value estimation unit 108. The parameter selection unit 1106 according to the present exemplary embodiment selects pre-processing use parameters and use parameters for generating feature data.

An abnormality detection unit 1107 detects an abnormality by pattern recognition, based on feature data obtained after the pre-processing use parameters and the use parameters for generating feature data are set in the pre-processing unit 1102 and the feature data generation unit 1103, respectively.

The estimation models stored in an estimation model storage unit 107 according to the present exemplary embodiment are regression models for predicting recognition performance based on feature data of a moving image obtained in a scene where no abnormality is caused. In other words, the estimation models according to the present exemplary embodiment are regression models in which feature data obtained from a moving image obtained from a scene in which no abnormality is caused is used as an explanatory variable and recognition performance is used as an objective variable.

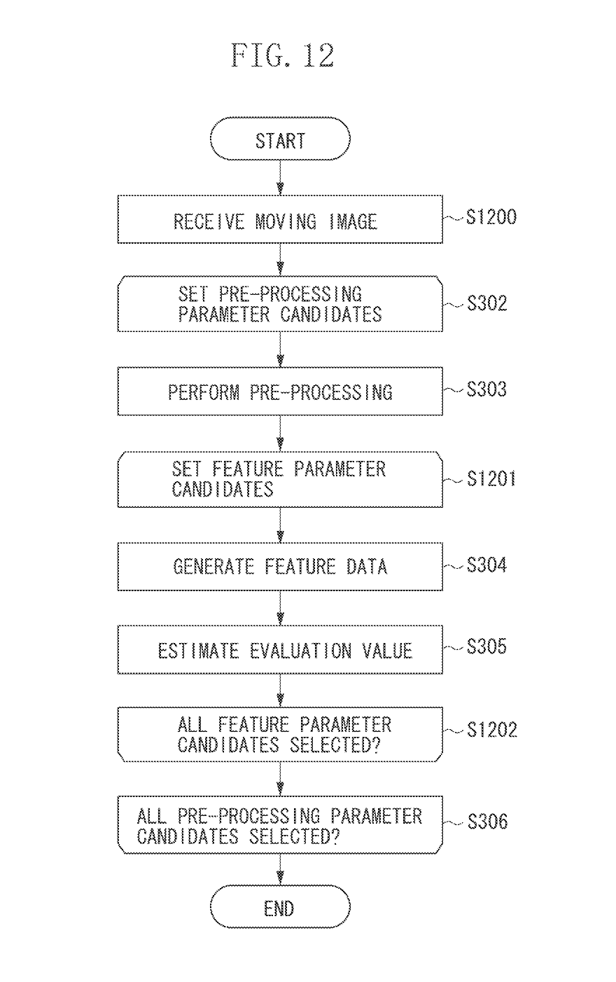

FIG. 12 is a flowchart illustrating evaluation value estimation processing performed by the pattern recognition apparatus 12. In step S1200, the pre-processing unit 1102 receives a moving image. Then, the processing proceeds to step S302. According to the present exemplary embodiment, the pre-processing unit 1102 receives a moving image from the monitoring camera 1101. In step S1200, the pre-processing unit 1102 receives a moving image captured in a scene where no abnormality is caused.

After pre-processing parameter candidates are set in the pre-processing unit 1102 in step S302, the processing proceeds to step S303. In step S303, the pre-processing unit 1102 performs pre-processing on the moving image and generates an intermediate moving image.

Next, in step S1201, the parameter setting unit 1105 sets feature parameter candidates in the feature data generation unit 1103. The processing from step S1201 to step S1202 is repeated. Each time the processing from step S1201 to step S1202 is repeated, the parameter setting unit 1105 selects one unprocessed combination of feature parameter candidates. Until the parameter setting unit 1105 selects all the combinations of feature parameter candidates in step S1201, the processing from step S1201 to step S1202 is repeated.

In this way, the pattern recognition apparatus 12 according to the third exemplary embodiment can estimate evaluation values for the feature parameter candidates.

Other processing in the evaluation value estimation processing according to the third exemplary embodiment is the same as that in the evaluation value estimation processing according to the first exemplary embodiment.

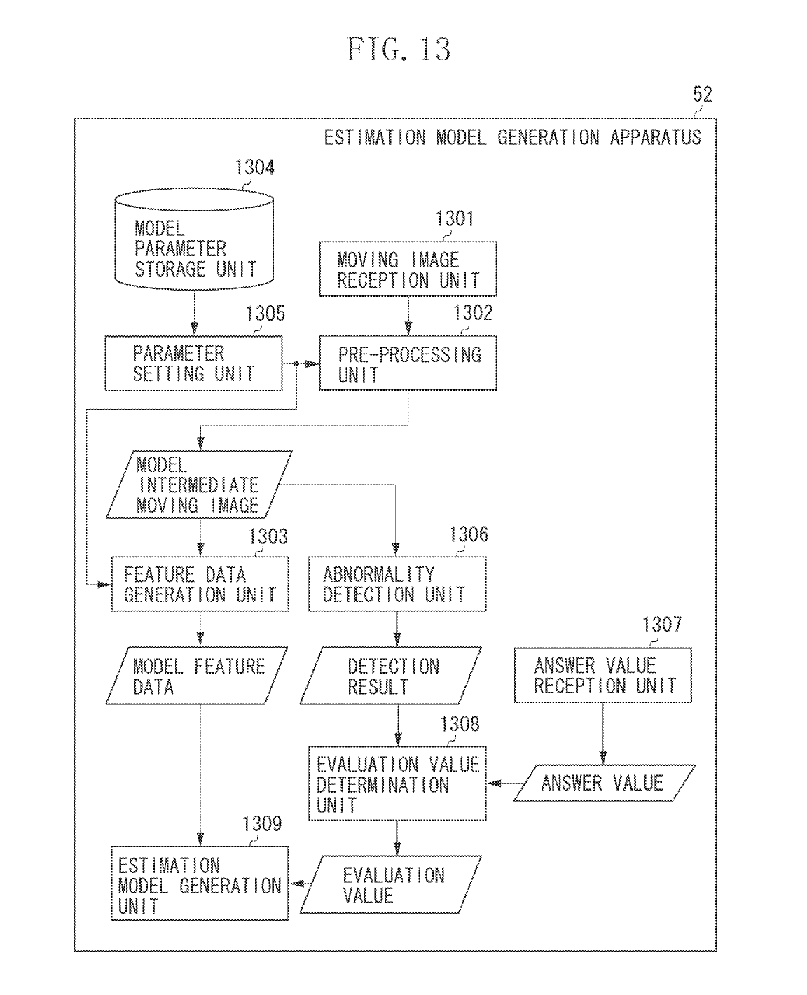

FIG. 13 illustrates a functional configuration of the estimation model generation apparatus 52 according to the third exemplary embodiment. Some of the functions of the estimation model generation apparatus 52 are the same as those of the estimation model generation apparatus 50 according to the first exemplary embodiment. Thus, the same functions are denoted by the same reference numerals.

The estimation model generation apparatus 52 generates an estimation model based on a moving image included in each of a plurality of moving image sets prepared by a user. Each moving image set includes a plurality of normal moving images and a plurality of abnormal moving images captured in a single environment. In addition, a plurality of moving image sets are sets of normal moving images and abnormal moving images captured in different environments. Different environments refer to different areas in a monitoring area and different monitoring areas, for example.

An intermediate moving image of an abnormal moving image is used for obtaining recognition performance (evaluation value) as an objective variable. Therefore, the estimation model generation apparatus 52 does not extract a feature vector from an intermediate moving image of an abnormal moving image.

A moving image reception unit 1301 illustrated in FIG. 13 receives a moving image from an external apparatus, for example. A pre-processing unit 1302 and a feature data generation unit 1303 correspond to the pre-processing unit 1102 and the feature data generation unit 1103 in the pattern recognition apparatus 12 illustrated in FIG. 11, respectively. A model parameter storage unit 1304, a parameter setting unit 1305, and an abnormality detection unit 1306 correspond to the parameter candidate storage unit 1104, the parameter setting unit 1105, and the abnormality detection unit 1107, respectively.

An intermediate moving images obtained by the pre-processing unit 1302 will be referred to as a model intermediate moving image. In addition, the feature data obtained by the feature data generation unit 1303 will be referred to as model feature data.

An answer value reception unit 1307 receives an answer value indicating that an input moving image is a normal moving image or an abnormal moving image. An evaluation value determination unit 1308 determines an evaluation value based on an answer value received by the answer value reception unit 1307 and a detection result obtained by the abnormality detection unit 1306.

An estimation model generation unit 1309 generates an SVR regression function model as an estimation model based on the model feature data generated by the feature data generation unit 1303 and the evaluation value determined by the evaluation value determination unit 1308.

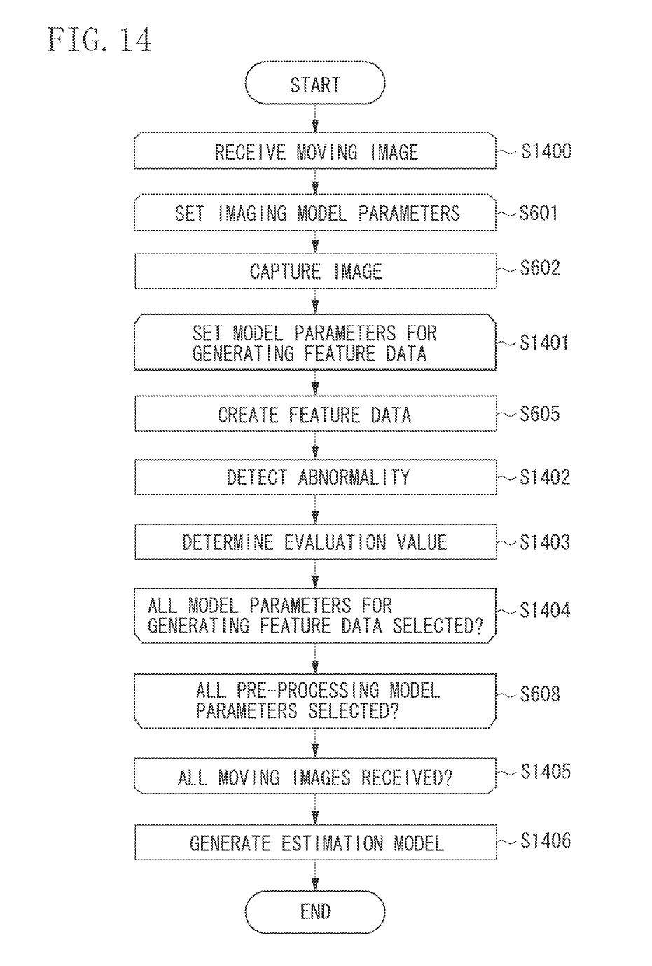

FIG. 14 is a flowchart illustrating model generation processing performed by the estimation model generation apparatus 52. Before the model generation processing according to the present exemplary embodiment is started, a user prepares a plurality of moving image sets captured in a plurality of environments, respectively.

In the model generation processing, the estimation model generation apparatus 52 generates data including combinations of feature vectors generated from normal moving images and evaluation values determined from intermediate moving images of normal moving images and abnormal moving images and generates estimation models based on the generated data.

In step S1400, the moving image reception unit 1301 receives a processing target moving image and the answer value reception unit 1307 receives an answer value for the processing target moving image. For example, when the moving image reception unit 1301 receives a normal moving image, the user inputs an answer value indicating normality. When the moving image reception unit 1301 receives an abnormal moving image, the user inputs an answer value indicating abnormality.

The processing from step S1400 to step S1405 is repeated. Each time the processing from step S1400 to step S1405 is repeated, the moving image reception unit 1301 and the answer value reception unit 1307 receive a moving image for generating an estimation model and an answer value, respectively.

Hereinafter, an example will be described, assuming that there are Ns kinds of environments in which moving images for generating estimation models are captured and that Nok normal moving images and Nng abnormal moving images are captured in each environment. In such a case, for one kind of environment, each of the Nok normal moving images and Nng abnormal moving images and an answer value corresponding thereto are sequentially input to the estimation model generation apparatus 52.

In other words, the estimation model generation apparatus 52 performs the processing from step S1400 to step S1405 on each of the moving images (normal moving images and abnormal moving images) included in each kind of moving image set. The estimation model generation apparatus 52 according to the present exemplary embodiment first processes the Nok normal moving images and next processes the Nng abnormal moving images.

Next, in step S601, the parameter setting unit 1305 sets pre-processing model parameters. Next, in step S602, the pre-processing unit 1302 performs pre-processing to obtain a model intermediate moving image. Next, in step S1401, the parameter setting unit 1305 sets model parameters for generating feature data. In step S605, the feature data generation unit 1303 generates model feature data. As described above, only the feature vectors generated from normal moving images are used as explanatory variables when estimation models are generated.

Next, in step S1402, the abnormality detection unit 1306 detects abnormality based on the model intermediate moving image. Next, in step S1403, the evaluation value determination unit 1308 determines an evaluation value for the set model parameters based on the detection result obtained by the abnormality detection unit 1306 and the answer value. More specifically, if abnormality is detected while the answer value does not indicate abnormality, the evaluation value determination unit 1308 determines that this is a failure case. If abnormality is not detected while the answer value indicates abnormality, the evaluation value determination unit 1308 also determines that this is a failure case. In the repetitive processing from step S601 to step S608, the evaluation value determination unit 1308 determines the number of failure cases per environment kind and determines the number to be an evaluation value per environment kind for one combination of model parameters.

In step S1404, the CPU 201 repeats the processing from step S1401 to step S1402 on all the model parameters for generating feature data. Next, the processing proceeds to step S608. After step S608, the processing proceeds to step S1405. In step S1405, the CPU 201 repeats the processing from step S601 to step S608 on all the moving images. Next, the processing proceeds to step S1406.

In step S1406, the estimation model generation unit 1309 generates an estimation model based on the combinations of data obtained through the processing until step S1405.

As described above, the estimation model generation apparatus 52 according to the third exemplary embodiment is compatible with the pattern recognition apparatus 12 and generates estimation models based on intermediate images obtained by using a plurality of parameters including parameters relating to generation of feature data.

Other configurations and processing of the pattern recognition apparatus 12 and the estimation model generation apparatus 52 according to the third exemplary embodiment are the same as those of the pattern recognition apparatuses and the estimation model generation apparatuses according to the above exemplary embodiments.

By using the pattern recognition apparatus 12 and the estimation model generation apparatus 52 according to the present exemplary embodiment, for example, appropriate parameters can be set in a monitoring camera newly installed in a monitoring area. The parameters in the pattern recognition apparatus 12 and the estimation model generation apparatus 52 may regularly be evaluated or reset.

A modification of the third exemplary embodiment will be described. The monitoring camera 1101 may not be included in the pattern recognition apparatus 12. In such a case, the pattern recognition apparatus 12 can receive moving images captured by a monitoring camera or the like from the outside.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)N, a flash memory device, a memory card, and the like.

According to each of the exemplary embodiments described above, it is possible to set appropriate parameters for pattern recognition while reducing a processing amount and a memory capacity for processing.

While exemplary embodiments of the present invention have thus been described in detail, the present invention is not limited thereto. Various variation and modifications are possible within the gist of the present invention described in the claims.

According to the present invention, it is possible to set appropriate parameters for pattern recognition while reducing a processing amount and a memory capacity for processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-225673 filed Oct. 30, 2013, which is hereby incorporated by reference herein in its entirety.

What is claimed is:

1. An information processing apparatus comprising:
a first setting unit configured to set at least one parameter candidate to be used for pattern recognition;
a first feature data generation unit configured to generate at least one feature data of at least one image data obtained by using the at least one parameter candidate set by the first setting unit;
a storage unit configured to store an estimation model, which is a modelization of a relationship between at least one feature data of a plurality of image data obtained by using each of a plurality of model parameters and an evaluation value for each of the plurality of the model parameters; and
an estimation unit configured to refer to the estimation model and estimate an evaluation value for each of the at least one parameter candidate based on each of the at least one feature data generated by the first feature data generation unit.

2. The information processing apparatus according to claim 1, further comprising:
an imaging unit configured to capture the at least one image data by using the at least one parameter set by the first setting unit, the at least one parameter relating to an imaging condition,
wherein the first feature data generation unit generates the at least one feature data of the at least one image data obtained by the imaging unit, and
wherein the storage unit stores the estimation model, which is a modelization of a relationship between at least one feature data of each of a plurality of image data captured by using each of the plurality of model parameters and the evaluation value for each of the plurality of the model parameters, each of the plurality of model parameters relating to the imaging condition.

3. The information processing apparatus according to claim 1, further comprising:
an image processing unit configured to perform image processing on the at least one image data by using the at least one parameter candidate set by the first setting unit, the at least one parameter candidate relating to image processing,
wherein the first feature data generation unit generates the at least one feature data of the at least one image data obtained by performing image processing, and
wherein the storage unit stores the estimation model which is a modelization of a relationship between at least one feature data of each of a plurality of image data obtained by performing image processing using each of the plurality of model parameters and the evaluation value for each of the model parameters, each of the plurality of model parameters relating to the image processing.

4. The information processing apparatus according to claim 1,
wherein the first feature data generation unit generates a plurality of feature data corresponding to each of a plurality of different parameter candidates set by the first setting unit,
wherein the estimation unit refers to the estimation model and estimates an evaluation value for each of a plurality of parameter candidates based on each of the plurality of feature data, and
wherein the information processing apparatus further comprises:
a selection unit configured to select a use parameter used for pattern recognition from the plurality of parameter candidates based on a plurality of evaluation values estimated by the estimation unit, the use parameter to be used for obtaining image data; and
a recognition unit configured to perform pattern recognition based on image data obtained by using the use parameter.

5. The information processing apparatus according to claim 1, further comprising:
a second setting unit configured to set the model parameters;
a second feature data generation unit configured to generate model feature data of each of a plurality of model image data obtained by using each of the plurality of model parameters set by the second setting unit; and
a model generation unit configured to generate the estimation model based on the model image data, the model feature data, and one or more answer values for the model image data,
wherein the storage unit stores the estimation model generated by the model generation unit.

6. An information processing apparatus comprising:
a first setting unit configured to set at least one parameter candidate used for pattern recognition;
a first feature data generation unit configured to generate at least one feature data of at least one image data by using the at least one parameter candidate set by the first setting unit;
a storage unit configured to store an estimation model, which is a modelization of a relationship between a plurality of feature data obtained by using each of a plurality of model parameters and evaluation values for the model parameters; and
an estimation unit configured to refer to the estimation model and estimate an evaluation value for each of the at least one parameter candidate based on the at least one feature data generated by the first feature data generation unit.

7. The information processing apparatus according to claim 6,
wherein the first feature data generation unit generates a plurality of feature data corresponding to each of a plurality of different parameter candidates set by the first setting unit,
wherein the estimation unit refers to the estimation model and estimates an evaluation value for each of a plurality of parameter candidates based on each of the plurality of feature data, and
wherein the information processing apparatus further comprises:
a selection unit configured to select a use parameter used for pattern recognition from the plurality of parameter candidates based on a plurality of evaluation values estimated by the estimation unit, the use parameter to be used for obtaining feature data; and
a recognition unit configured to perform pattern recognition based on feature data obtained by using the use parameter.

8. The information processing apparatus according to claim 6, further comprising:
a second setting unit configured to set the model parameters;
a second feature data generation unit configured to generate a plurality of model feature data of model image data by using each of the plurality of model parameters set by the second setting unit; and
a model generation unit configured to generate the estimation model based on the model feature data, the model image data, and one or more answer values for the model image data,
wherein the storage unit stores the estimation model generated by the model generation unit.

9. The information processing apparatus according to claim 1, wherein the estimation model is a regression model in which the at least one feature data is used as an explanatory variable and the evaluation value for each of the at least one parameter candidate is used as an objective variable.

10. An information processing apparatus comprising:
a setting unit configured to set at least one model parameter for an estimation model for estimating an evaluation value for a parameter used for pattern recognition;
a feature data generation unit configured to generate model feature data of each of a plurality of model image data obtained by using each of a plurality of model parameters set by the setting unit; and
a model generation unit configured to generate the estimation model based on the model image data, the model feature data, and at least one answer value for the model image data.

11. An information processing apparatus comprising:
a setting unit configured to set at least one model parameter for an estimation model for estimating an evaluation value for a parameter to be used for pattern recognition;
a feature data generation unit configured to generate a plurality of model feature data of model image data by using each of a plurality of model parameters set by the setting unit; and
a model generation unit configured to generate the estimation model based on the model feature data, the model image data, and at least one answer value for the model image data.

12. An information processing method performed by an information processing apparatus, the method comprising:
setting a parameter candidate to be used for pattern recognition;
generating feature data of image data obtained by using the parameter candidate set in the setting;
referring to an estimation model which is a modelization of a relationship between feature data of a plurality of image data obtained by using each of a plurality of model parameters and an evaluation value for each of the model parameters, and
estimating an evaluation value for the set parameter candidate based on the feature data generated in the feature data generation.

13. An information processing method performed by an information processing apparatus, the method comprising:
setting a parameter candidate to be used for pattern recognition;
generating feature data of image data by using the parameter candidate set in the setting;
referring to an estimation model which is a modelization of a relationship between a plurality of feature data obtained by using each of a plurality of model parameters and an evaluation value for each of the model parameters, and
estimating an evaluation value for the set parameter candidate based on the feature data generated in the feature data generation.

14. An information processing method performed by an information processing apparatus, the method comprising:
setting at least one model parameter for an estimation model for estimating an evaluation value for a parameter to be used for pattern recognition;
generating model feature data of each of a plurality of model image data obtained by using each of a plurality of model parameters set in the setting; and
generating the estimation model based on the model image data, the model feature data, and at least one answer value for the model image data.

15. An information processing method performed by an information processing apparatus, the method comprising:
setting at least one model parameter for an estimation model for estimating an evaluation value for a parameter to be used for pattern recognition;
generating a plurality of model feature data of model image data by using each of a plurality of model parameters set in the setting; and
generating the estimation model based on the model feature data, the model image data, and at least one answer value for the model image data.

16. A storage medium storing a program for causing a computer to function as each unit in the information processing apparatus according to claim 1.

17. A storage medium storing a program for causing a computer to function as each unit in the information processing apparatus according to claim 6.

18. A storage medium storing a program for causing a computer to function as each unit in the information processing apparatus according to claim 10.

19. A storage medium storing a program for causing a computer to function as each unit in the information processing apparatus according to claim 11.

20. A storage medium storing a program for causing a computer to perform the steps in the information processing method according to claim 12.

21. A storage medium storing a program for causing a computer to perform the steps in the information processing method according to claim 13.

22. A storage medium storing a program for causing a computer to perform the steps in the information processing method according to claim 14.

23. A storage medium storing a program for causing a computer to perform the steps in the information processing method according to claim 15.
